(19) United States
(12) Patent Application Publication
(10) Pub. No.: US 2025/0017290 A1
(43) Pub. Date: Jan. 16, 2025

(54) BRA CUP

(71) Applicant: Regina Miracle International (Group) Limited, Kwai Chung (CN)

(72) Inventor: Zhenqiang LIU, Kwai Chung (CN)

(21) Appl. No.: 18/767,591

(22) Filed: Jul. 9, 2024

(30) Foreign Application Priority Data
Jul. 10, 2023 (CN) 202310843691.0

(51) Int. Cl. A41C 3/12; A41C 3/00

(52) U.S. Cl. CPC A41C 3/128; A41C 3/0014

(57) ABSTRACT

A bra cup includes: a body of a bra cup, the body of the bra cup having an outer layer and an inner layer, the body of the bra cup provided with an intermediate layer, the intermediate layer including a polyurethane, the polyurethane having the property of being easy to be stretched and extended when stretched at slow speeds while being tightened to protect when stretched at fast speeds. Through the provision of the polyurethane intermediate layer, the bra cup has the property of being easy to stretch and extend at slow speeds and tighten and protect at fast speeds. The bra cup can be applied to both work scenes and sports scene requirements.

### CROSS-REFERENCE TO RELATED APPLICATIONS

This application claims foreign priority to and the benefit of Chinese Patent Application No. 202310843691.0, filed on 10 Jul. 2023, the entire disclosure of which is incorporated herein by reference.

### TECHNICAL FIELD

The present disclosure relates to the technical field of bras, and in particular to a bra cup and any garment.

### BACKGROUND

In the prior art, bras and sports bras on the market add fabrics, films, underwire, and resin materials in the middle or on the surface of the bra cups to increase their performance, so that the bra cups can locally enhance support and play a role in shaping the breast. However, it is impossible to achieve in the same product the comfort and fit required for daily wear while also being suitable for protecting the breast during exercise and not shaking violently during exercise.

Therefore, how to provide a bra cup and clothing that can be used in both work and sports scenarios has become a technical problem that needs to be solved urgently.

### SUMMARY OF THE INVENTION

### Technical Problem

The technical problem to be solved by the present disclosure is how to provide a bra cup and a garment to be suitable for both work and sports scenarios.

### Technical Solution

According to a first aspect, an embodiment of the present disclosure discloses a bra cup comprising: a bra cup body, the bra cup body comprising an outer layer and an inner layer, the bra cup body further provided with an intermediate or middle layer, the intermediate or middle layer comprising a polyurethane layer, the polyurethane layer and hence the intermediate or middle layer having the property of being easy to stretch and extend at a slow stretching speed while being tightened for protection at a fast stretching speed.

According to a further aspect, an embodiment of the present disclosure discloses a bra cup comprising an outer layer, an inner layer, and an intermediate layer between the outer layer and the inner layer, wherein the intermediate layer comprises polyurethane and is easy to stretch or easily stretchable when stretched at a slow speed and is tightened for protection when stretched at a fast speed.

In one embodiment, the fast speed is 10 times or at least 10 times the slow speed.

According to a further aspect, an embodiment of the present disclosure discloses a bra cup comprising an outer layer, an inner layer, and an intermediate layer between the outer layer and the inner layer, wherein the intermediate layer comprises polyurethane, and when a force of at least 2 kg is applied to stretch the intermediate layer, an elongation of the intermediate layer in a direction of the applied force at a first stretching speed is at least 2.3times an elongation of the intermediate layer in the direction of the applied force at a second stretching speed which is at least 10 times the first stretching speed.

In one embodiment, the first stretching speed is 100 mm/min and the second stretching speed is 1000 mm/min or at least 1000 mm/min.

In one embodiment, there is further provided that the polyurethane layer is bonded and fixed to the outer layer and the inner layer respectively.

In one embodiment, there is further provided that the outer layer, the inner layer and the polyurethane layer are thermally pressed into one piece, or integrally formed by hot pressing.

In one embodiment, there is further provided that the intermediate or middle layer further comprises a fabric for localized or partial support of the bra cup body, the fabric being knitted, mesh, woven or non-woven fabric.

In one embodiment, there is further provided that the fabric is bonded and fixed to the outer layer and the inner layer, respectively.

In one embodiment, there is further provided that the outer layer, the inner layer, the polyurethane layer and the fabric are thermally pressed in one piece, or integrally formed by hot pressing.

In one embodiment, there is further provided that the outer layer is made of a single layer of fabric; or the outer layer is a composite of a single layer of fabric and a foam layer; or the outer layer is a composite of a single layer of fabric and another single layer of fabric.

In one embodiment, there is further provided that the inner layer is made of a single layer of fabric; or the inner layer is a composite of a single layer of fabric and a foam layer; or the inner layer is a composite of a single layer of fabric and another single layer of fabric.

In one embodiment, there is further provided that the polyurethane layer has a non-linear relationship between shear stress and shear strain.

In one embodiment, there is further provided that the polyurethane layer has a rebound force of no more than 20%.

In one embodiment, there is further provided that the polyurethane layer has a rebound force of 12-14%.

In one embodiment, there is further provided that the polyurethane layer comprises a plurality of through holes uniformly distributed, the plurality of through holes being polygonal or circular.

In one embodiment, there is further provided that the composition of the polyurethane layer comprises a polyol, an isocyanate and a chain extender, and the ratio of the weight content of the polyol, the isocyanate and the chain extender is 80.00 to 100.00:70.00 to 90.00:10.00 to 20.00. The polyol has an average functionality greater than or equal to 2, and the chain extender has an average functionality greater than 2.

In one embodiment, there is further provided that the molecular weight of the polyol is 300 to 2000, the molecular weight of the isocyanate is 320 to 400, and the molecular weight of the chain extender is 90 to 400.

In one embodiment, there is further provided that the molecular weight of the polyol is 500 to 1200, the molecular weight of the isocyanate is 350 to 370, and the molecular weight of the chain extender is 200 to 300.

In one embodiment, there is further provided that the ratio of the weight content of the polyol, the isocyanate and the chain extender is 85.00 to 95.00:75.00 to 85.00:13.00 to 17.00.

In one embodiment, there is further provided that the polyol is a polyether polyol or a polyester polyol, the chain extender is 1,4-butanediol, 1,6-hexanediol, diethylene glycol, dipropylene glycol, 1,2,3-propanetriol, or trimethylolpropane, and the polyol is dissimilar to the chain extender.

According to a further aspect, an embodiment of the present disclosure discloses a garment comprising a garment body and a bra cup as described in the foregoing, the bra cup being sewn or bonded to a local position of the garment body, the local position being a joint position or a muscle protection position of the garment body.

In one embodiment, there is further provided that the garment body is a bra.

### Beneficial Effect

The bra cup body comprises an outer layer and an inner layer and is provided with an intermediate layer, wherein the intermediate layer comprises a polyurethane layer, thereby providing a bra cup. By providing the polyurethane layer, the bra cup has the ability to easily stretch and expand when stretched at slow speeds, and to tighten to protect when stretched at high speeds. In addition, the intermediate layer is integrated with the bra cup, which has a simple and unmarked appearance. Thus, it can be applied to the needs of both work and sports scenarios.

### BRIEF DESCRIPTION OF THE DRAWINGS

In order to more clearly illustrate the technical solutions in the specific embodiments or prior art of the present disclosure, the accompanying drawings to be used in the description of the specific embodiments or prior art will be briefly introduced below, and it will be appreciated that the accompanying drawings in the following description show some of the embodiments of the present disclosure, and for a person of ordinary skill in the art, other drawings can be obtained according to these drawings without creative labor.

FIG. 1 is one of the schematic diagrams of a three-dimensional structure of a bra cup disclosed in the present disclosure;

FIG. 2 is a schematic diagram of a sectional structure of FIG. 1;

FIG. 3 is a schematic diagram of one of the three-dimensional structures of a bra cup disclosed in the present disclosure;

FIG. 4 is a schematic diagram of the sectional structure of FIG. 3; and

FIG. 5 is a graph comparing the tensile test results of a conventional TPU and a polyurethane material of the present disclosure.

The accompanying drawings are labeled: 1, outer layer; 2, inner layer; 3, polyurethane layer; and 4, fabric.

### Detailed Description of Specific Embodiments

In order to make the objects, technical solutions and advantages of the present disclosure clearer and more understandable, the present disclosure is described in further detail hereinafter in conjunction with the accompanying drawings and embodiments. It should be understood that the specific embodiments described herein are for the sole purpose of explaining the present disclosure and are not intended to limit the present disclosure.

In the description of the present disclosure, it is to be noted that, unless otherwise expressly provided and limited, the terms “mounted”, “connected”, and “connected” are to be broadly construed. For example, it may be a fixed connection, a removable connection, or a connection in one piece; it may be a mechanical connection or an electrical connection; it may be a direct connection or an indirect connection through an intermediate medium, or a connection within two elements; it may be a wireless connection or a wired connection. For those of ordinary skill in the art, the specific meaning of the above terms in the present disclosure can be understood in specific cases.

In the description of the present disclosure, it is to be noted that the terms “center”, “up”, “down”, “left” “right”, “vertical”, “horizontal”, “inner”, “outer”, etc. indicate an orientation. The orientation or positional relationships indicated by “left”, “right”, “vertical”, “horizontal”, “inner”, “outer”, etc. are based on those shown in the accompanying drawings, and are intended only to facilitate description of the present disclosure and to simplify the description, and are not intended to indicate or imply that the device or element referred to must be constructed and operated with a particular orientation, and therefore are not to be construed as a limitation of the present disclosure. Furthermore, the terms “first”, “second”, and “third” are used for descriptive purposes only, and are not to be construed as indicating or implying relative importance.

In addition, the technical features involved in the different embodiments of the present disclosure described below may be combined with each other as long as they do not conflict with each other.

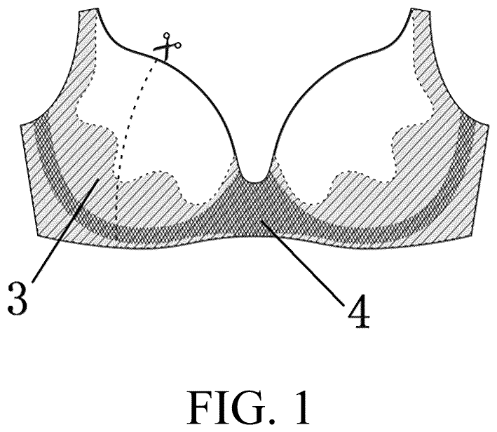

The present disclosure discloses a bra cup, and specific structures of the bra cup according to embodiments of the present disclosure will be described in detail below with reference to FIGS. 1 to 4.

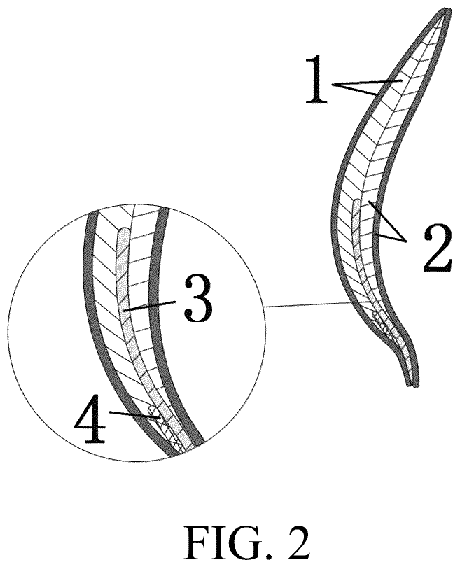

According to an embodiment of the present disclosure, as shown in FIGS. 1 and 2, the bra cup comprises: a bra cup body, the bra cup body comprising an outer layer 1 and an inner layer 2, and an intermediate layer is provided within the bra cup body, the intermediate layer comprising a polyurethane such as a thermosetting polyurethane, or a polyurethane layer 3. In the present disclosure, the polyurethane or the polyurethane layer 3 has the following property or characteristics: it is easily stretched and extended when stretched at a slow speed, while it is not easily stretched but is tightened to protect a user's breast when stretched at a fast speed. According to the bra cup of the present disclosure, the polyurethane layer 3 is provided so that the bra cup has the property that it is easy to stretch and lengthen at low speeds and tightens and protects (the breast) at high speeds.

In addition, the intermediate layer is integrated with the bra cup, which has a simple and unmarked appearance. It is also applicable to the needs of work and sports scenarios.

As shown in FIG. 2, the polyurethane layer 3 is bonded and fixed to the outer layer 1 and inner layer 2, respectively.

As shown in FIGS. 1 and 2, the outer layer 1, the inner layer 2 and the polyurethane layer 3 are molded in one piece by hot pressing. In a specific embodiment, the surfaces of the outer layer 1, the inner layer 2 and the polyurethane layer 3 are covered with adhesive, stacked and then molded with a mold at a high temperature (160-195° C.), and the adhesive bond is not easy to fall off.

As shown in FIGS. 1 and 2, the intermediate layer may further comprise a fabric 4 for localized support of the body of the bra cup. It is to be noted that the fabric 4 may be a knitted fabric, a mesh fabric, a woven fabric or a non-woven fabric. In a specific embodiment, referring to FIGS. 1 and 2, the fabric 4 may be located in a lower portion of the bra cup body. Further, as shown in FIG. 2, the fabric 4 may be disposed above or on the outer side of the polyurethane layer 3 and at least partially overlap the lower portion of the polyurethane layer 3.

In addition, the present disclosure does not limit the shape of the polyurethane layer 3 and the fabric 4. The shape of the polyurethane layer 3 and the fabric 4 may be smaller than the bra cup, and the shape of the polyurethane layer 3 and the fabric 4 may be as large as the bra cup.

The fabric 4 is bonded and fixed to the outer layer 1 and the inner layer 2, respectively, as shown in FIGS. 1 and 2.

The outer layer 1, the inner layer 2, the polyurethane layer 3 and the fabric 4 may be hot pressed into one piece as shown in FIGS. 1 and 2. In a specific embodiment, the surfaces of the outer layer 1, the inner layer 2, the polyurethane layer 3 and the fabric 4 are covered with adhesive, stacked and then molded with a mold at a high temperature (160-195° C.), and the adhesive bond is not easy to fall off.

As shown in FIGS. 1 and 2, the outer layer 1 is made of a single layer of fabric; or the outer layer 1 is a composite of a single layer of fabric and a foam layer; or the outer layer 1 is a composite of a single layer of fabric and another single layer of fabric. In specific embodiments, the outer layer 1 may be a conventional bra cup fabric and a foam layer, and the outer layer 1 may also be a multi-layer fabric structure.

As shown in FIGS. 1 and 2, the inner layer 2 is made of a single layer of fabric; or the inner layer 2 is a composite of a single layer of fabric and a foam layer; or the inner layer 2 is a composite of a single layer of fabric and another single layer of fabric. In specific embodiments, the inner layer 2 may be a conventional bra cup fabric and foam layer, and the outer layer 1 may also be a multi-layer fabric structure.

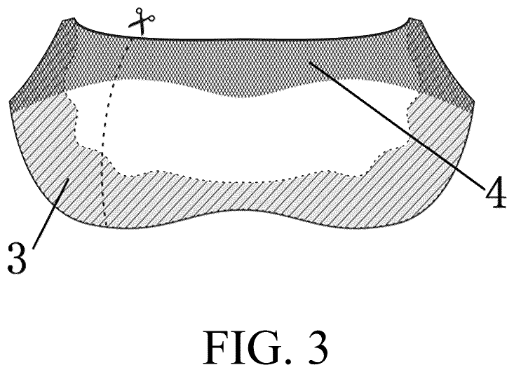

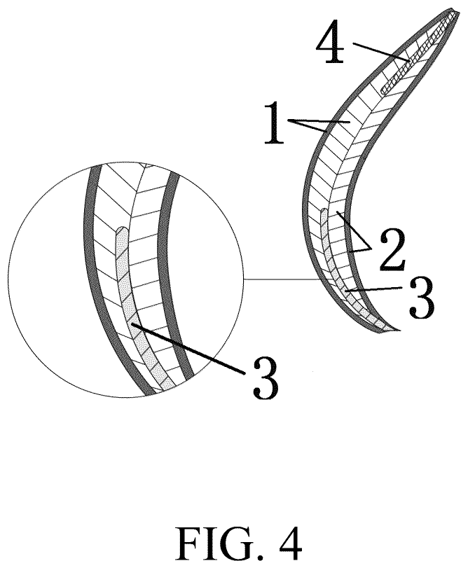

According to another embodiment of the present disclosure, as shown in FIGS. 3 and 4, the bra cup of the present disclosure comprises: a bra cup body, the bra cup body comprising an outer layer 1 and an inner layer 2, and an intermediate layer is provided within the bra cup body, the intermediate layer comprising a polyurethane such as a thermosetting polyurethane.

The intermediate layer comprises a polyurethane layer 3. The polyurethane layer 3 is bonded and fixed to the outer layer 1 and the inner layer 2, respectively, as shown in FIG. 4.

The outer layer 1, the inner layer 2 and the polyurethane layer 3 may be hot pressed into one piece as shown in FIGS. 3 and 4. In the specific embodiment, the surfaces of the outer layer 1, the inner layer 2 and the polyurethane layer 3 are covered with adhesive, stacked and then molded with a mold at a high temperature (160-195° C.), and the adhesive bond is not easy to fall off.

As shown in FIGS. 3 and 4, the intermediate layer further comprises a fabric 4 for localized support of the body of the bra cup. It is to be noted that the fabric 4 may be a knitted fabric, a mesh fabric, a woven fabric or a non-woven fabric. In a specific embodiment, referring to FIGS. 3 and 4, the fabric 4 may be located in an upper portion of the bra cup body. Further, as shown in FIG. 4, the fabric 4 may be disposed below the polyurethane layer 3 and does not overlap the polyurethane layer 3.

The fabric 4 is bonded and fixed to the outer layer 1 and the inner layer 2, respectively, as shown in FIGS. 3 and 4.

The outer layer 1, the base layer 2, the polyurethane layer 3 and the fabric 4 may be hot pressed into one piece as shown in FIGS. 3 and 4. In a specific embodiment, the surfaces of the outer layer 1, the inner layer 2, the polyurethane layer 3 and the fabric 4 are covered with adhesive, stacked and then molded with a mold at a high temperature (160-195° C.), and the adhesive bond is not easy to fall off.

As shown in FIGS. 3 and 4, the outer layer 1 is made of a single layer of fabric; or the outer layer 1 is a composite of a single layer of fabric and a foam layer; or the outer layer 1 is a composite of a single layer of fabric and another single layer of fabric. In specific embodiments, the outer layer 1 may be a conventional bra cup fabric and foam layer, and the outer layer 1 may also be a multi-layer fabric structure.

As shown in FIGS. 3 and 4, the inner layer 2 is made of a single layer of fabric; or the inner layer 2 is a composite of a single layer of fabric and a foam layer; or the inner layer 2 is a composite of a single layer of fabric and another single layer of fabric. In specific embodiments, the inner layer 2 may be a conventional bra cup fabric and foam layer, and the outer layer 1 may also be a multi-layer fabric structure.

It should be noted that although examples of the relative positions and shapes of the polyurethane layer 3 and the fabric 4 are given in the specific embodiments described above, they are illustrative only and not limiting. For example, the polyurethane layer 3 may be above, below or to the side of the fabric 4, etc., and the two may even overlap, partially overlap or not overlap at all. In addition, the present disclosure does not limit the shape of the polyurethane layer 3 and the fabric 4. The shape of the polyurethane layer 3 and the fabric 4 can be smaller than a bra cup, and the shape of the polyurethane layer 3 and the fabric 4 can be as large as a bra cup.

As described above, the polyurethane used in the present disclosure has the following characteristics: it is easy to be stretched and extended when stretched at slow or low speeds, while it is not easy to be stretched but is tightened and protective (for the breast) when stretched at fast or high speeds. The polyurethane used in the bra cup of the present disclosure is described further below.

According to an embodiment of the present disclosure, the composition of the polyurethane used in the present disclosure may comprise a polyol (Polyol), an isocyanate (Isocyanate), and a chain extender (Chain extender), wherein the ratio by weight of the polyol, the isocyanate, and the chain extender is 80.00 to 100.00:70.00 to 90.00:10.00 to 20.00, and the average functionality of the polyol is greater than or equal to 2, and the average functionality of the chain extender is greater than 2.

Molecules with a functionality of 1 generate only dimers, molecules with a functionality of 2 generate linear polymers, and molecules with a functionality greater than 2 generate steric polymers that are stronger than linear polymers. Since in the polyurethane used in the present disclosure, the average functionality of the polyol is greater than or equal to 2 and the average functionality of the chain extender is greater than 2, stereospecific polymers can be formed with better structural strength and good shock absorption and cushioning in multiple dimensions.

As an example, the molecular weight of the polyol may be 300 to 2000, the molecular weight of the isocyanate may be 320 to 400, and the molecular weight of the chain extender may be 90 to 400.

Further, the molecular weight of the polyol may be 500 to 1200, the molecular weight of the isocyanate may be 350 to 370, and the molecular weight of the chain extender may be 200 to 300. For example, the isocyanate may be hexamethylene diisocyanate (Isocyanate) having a molecular weight of about 361.

As an example, the weight ratio of the polyol, the isocyanate and the chain extender may be 85.00 to 95.00:75.00 to 85.00:13.00 to 17.00. Preferably, the weight ratio of the polyol, the isocyanate and the chain extender may be 90.00:79.00:15.00. For example, the weight ratio of the polyol, the isocyanate and the chain extender may be 52:40:8.

By way of example, the polyol may be a polyether polyol or a polyester polyol, and the chain extender may be 1,4-butanediol, 1,6-hexanediol, diethylene glycol, dipropylene glycol, 1,2,3-propanetriol, or trimethylolpropane, and the polyol is dissimilar to the chain extender.

According to an embodiment of the present disclosure, as an example, the polyurethane of the present disclosure may have a non-linear relationship between shear stress and shear strain. As a result, energy can be absorbed in large quantities and quickly when impacted by an external force, and the polyurethane layer 3 can reduce the rebound effect and further enhance the shock absorption and cushioning effect.

As an example, the polyurethane layer 3 of the present disclosure may have a rebound force of no more than 20%. Further, the rebound force of the polyurethane layer 3 may be, for example, 12 to 14%. The rebound force is a percentage of the rebound height relative to the drop height, wherein the drop height is the height of the object from the polyurethane layer 3, and the rebound height is the height of the object from the polyurethane layer 3 after being rebounded by the polyurethane layer 3.

According to an embodiment of the present disclosure, as an example, the polyurethane layer 3 may include a plurality of through holes evenly distributed therein. Utilizing these through-holes can be material-saving, lightweight, and low-cost, and can also provide good physical permeability (e.g., air permeability, liquid permeability, etc.). Further, the shape of these plurality of through-holes may be polygonal (such as hexagonal) or circular.

As another example, the polyurethane layer 3 may not have any through-holes, thereby providing an adequate shock-absorbing cushioning effect.

To better illustrate the properties or characteristics of the polyurethane used in the present disclosure, the results of tensile or stretch testing of the polyurethane are given in Table 1 below.

TABLE 1
Tensile test results of the polyurethane of the present disclosure

| | | | | Tensile Test | | | | | | |
|---|---|---|---|---|---|---|---|---|---|---|
| Serial | | | Testing | | | | | | Recovery | Tensile |
| No. | Color | Fabric | Position | 2 kg(%) | 80%(kg) | 60%(kg) | 40%(kg) | 20%(kg) | (%) | speed |
| 1 | Transparent | Polyurethane | L | 75.1 | — | 1.53 | 0.95 | 0.43 | 52.19 | Speed |
| 2 | | material | | 71.6 | — | 1.62 | 0.99 | 0.46 | 48.80 | 100 mm/min |
| 5 | | | L | 23.5 | — | — | — | 1.48 | 29.43 | Speed |
| 6 | | | | 21.7 | — | — | — | 1.73 | 29.60 | 1000 mm/min |

The method of tensile or stretch testing is as follows: Step 1: Take out the standard sample, fix it in the upper and lower fixtures of the tensile machine, and then stretch it to 2 kg at a constant speed, with reference to the modulus during the stretching process (20%, 40%, 60%, 80% of the force received and the change in total elongation); Step 2: Remove the sample after the test is completed, and measure the length of the sample after 1 minute and 30 minutes in order to calculate the recovery rate. This method monitors the change in modulus and the recovery rate of the sample under tensile force at a fixed force value.

In Table 1, the 2 kg (%) column corresponds to using 2 kg of force to see how much length the polyurethane can stretch. The 80%, 60%, 40%, and 20% columns correspond to the amount of force required to stretch a certain percentage length. The recovery rate is calculated as (maximum stretched length−length after recovery)/(maximum stretched length-original length)*100%.

Two different stretching speeds, i.e., slow stretching speed (e.g., 100 mm/min) and fast stretching speed (e.g., 1000 mm/min) were used in the tensile tests, and then the two scenarios of slow and fast stretching were simulated using the above-mentioned tensile test method, and experimental results such as recovery rate were recorded. The experimental results show that for the same tensile force, the recovery rate is significantly lower for fast stretching than for slow stretching (23.5<75.1).

From the 2 kg (%) column in Table 1, which shows the percentage of length of the polyurethane used in the present disclosure that can be stretched with a force of 2 kg, the ratio of the length stretched by the slow stretching speed to the length stretched by the fast stretching speed is 71.6 (at a slow stretching speed of 100 mm/min)−21.7 (at a fast stretching speed of 1000 mm/min)/21.7=2.3. This means that when a tensile or stretching force of 2kg is applied to the sample of the polyurethane of the present disclosure, the length stretched when the polyurethane is stretched at the slow speed is 2.3 or at least 2.3 times the length stretched when the polyurethane is stretched at the fast speed, which is 10 times or at least 10 times the slow speed.

It can be seen from the above table that if a faster stretching speed is set, the protective effect of the polyurethane material will be further improved. It can be seen that, as shown in the above test results, the polyurethane used in the present disclosure only undergoes a slight deformation when subjected to an instantaneous external force impact.

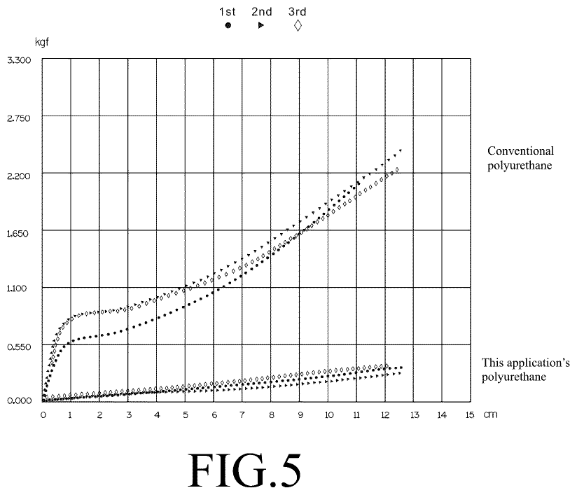

Furthermore, in another tensile test, a common thermoplastic polyurethane (TPU) material and the polyurethane material of the present disclosure were tensile tested at a much lower tensile speed of, for example, 25 mm/min, and the test results are shown in FIG. 5. According to the tensile test results in FIG. 5, the force required to pull the TPU film at low speeds is large, and the tensile force required increases dramatically as the amount of deformation increases, increasing to about 2.200 kgf for a tensile deformation of 12 cm; however, the force required to pull the polyurethane material of the present disclosure at low speeds is very small, with a tensile force of about 0.400 kgf for a tensile deformation of 12 cm, which makes the polyurethane material of the present disclosure suitable for wear and comfort. This makes it suitable for the mobility and comfort needs of wearable object.

In the prior art, thermoplastic polyurethane, which has low heat resistance, is usually used, and when subjected to an instantaneous external force, it will elongate and deform according to the direction of the force, and thus the protective power is weak. In order to solve the above problem, a new polyurethane is used in the embodiments of the present disclosure, which is easy to stretch and lengthen when being stretched at a slow speed and tightens to protect when being stretched at a fast speed, thereby improving the protective performance of bra cups and garments using the new polyurethane for the intermediate layer.

An embodiment of the present disclosure discloses a garment comprising a garment body and a cup (for the garment) similar to the bra cup as described in the aforesaid, the cup being sewn or bonded to a localized position of the garment body, the localized position being located in a joint or muscle protection position of the garment body. For example, the cup can be applied in a bra, sportswear or sports shoes, or knee pads. When the user does high-frequency strenuous exercise, the cup can provide comfortable wrapping function while at the same time providing protection from joint or muscle injury.

In specific embodiments, the body of the garment is a bra. When the user wears the bra comprising the bra cups described above, the bra cups will be naturally pulled apart according to the user's body shape for a more comfortable fit. When the user is doing a strenuous exercise, the bra cup will automatically tighten to protect the user's breast, avoiding the user's breast from shaking violently and causing injury.

It will be appreciated that the above embodiments are merely examples for the purpose of clear illustration and are not a limitation of the embodiments. To a person of ordinary skill in the art, other variations or modifications in different forms may be made on the basis of the above description. It is neither necessary nor possible to exhaust all the embodiments herein, and obvious variations or modifications derived therefrom remain within the scope of protection of the present disclosure.

What is claimed is:

1. A bra cup comprising an outer layer, an inner layer, and an intermediate layer between the outer layer and the inner layer, the intermediate layer comprising a polyurethane layer, wherein the polyurethane layer is easily stretched and extended when stretched at a slow speed and is tightened for protection when stretched at a fast speed.

2. The bra cup according to claim 1, wherein the outer layer, the inner layer and the polyurethane layer are integrally molded by hot pressing.

3. The bra cup according to claim 1, wherein the intermediate layer further comprises a fabric for partially supporting the bra cup, wherein the fabric is a knitted fabric, a mesh fabric, or a non-woven fabric.

4. The bra cup according to claim 3, wherein the outer layer, the inner layer, the polyurethane layer, and the fabric are integrally formed by hot pressing.

5. The bra cup according to claim 1, wherein the polyurethane layer has a non-linear relationship between shear stress and shear strain.

6. The bra cup according to claim 1, wherein the polyurethane layer has a rebound force of not more than 20%.

7. The bra cup according to claim 6, wherein the polyurethane layer has a rebound force of 12-14%.

8. The bra cup according to claim 1, wherein the polyurethane layer comprises a plurality of through holes uniformly distributed, the plurality of through holes being polygonal or circular.

9. The bra cup according to claim 1, wherein the composition of the polyurethane layer comprises polyol, isocyanate, and chain extender, wherein the ratio by weight of the polyol, the isocyanate, and the chain extender is 80.00 to 100.00:70.00 to 90.00:10.00 to 20.00, the polyol has an average functionality greater than or equal to 2, and the chain extender has an average functionality greater than 2.

10. The bra cup according to claim 9, wherein the molecular weight of the polyol is 300 to 2000, the molecular weight of the isocyanate is 320 to 400, and the molecular weight of the chain extender is 90 to 400.

11. The bra cup according to claim 10, wherein the molecular weight of the polyol is 500 to 1200, the molecular weight of the isocyanate is 350 to 370, and the molecular weight of the chain extender is 200 to 300.

12. The bra cup according to claim 9, wherein the weight ratio of the polyol, the isocyanate, and the chain extender is 85.00 to 95.00:75.00 to 85.00:13.00 to 17.00.

13. The bra cup according to claim 9, wherein the polyol is a polyether polyol or a polyester polyol, the chain extender is 1,4-butanediol, 1,6-hexanediol, diethylene glycol, di-propylene glycol, 1,2,3-propanetriol, or trimethylolpropane, and the polyol is dissimilar to the chain extender.

14. A bra cup comprising an outer layer, an inner layer, and an intermediate layer between the outer layer and the inner layer, wherein the intermediate layer comprises polyurethane, and when a force of at least 2 kg is applied to stretch the intermediate layer, an elongation of the intermediate layer in a direction of the applied force at a first stretching speed is at least 2.3 times an elongation of the intermediate layer in the direction of the applied force at a second stretching speed which is at least 10 times the first stretching speed.

15. The bra cup according to claim 14, wherein the first stretching speed is 100 mm/min and the second stretching speed is at least 1000 mm/min.
